(19) United States
(12) Patent Application Publication
(10) Pub. No.: US 2007/0094022 A1
(43) Pub. Date: Apr. 26, 2007

(54) Method and device for recognizing human intent

(76) Inventors: Hahn Koo, Savoy, IL (US); Yan Ming Cheng, Inverness, IL (US)

Correspondence Address: MOTOROLA, INC., 1303 EAST ALGONQUIN ROAD, IL01/3RD, SCHAUMBURG, IL, 60196, US

(21) Appl. No.: 11/254,431

(22) Filed: Oct. 20, 2005

(51) Int. Cl. G10L 15/04

(52) U.S. Cl. 704/251

(57) ABSTRACT

A method (300) and apparatus (100) for recognizing human intent includes capabilities of recognizing (305) a sequence of words by a expression recognizer (115), and determining (310) a most likely value of a replacement for a target word in the sequence of words using the target word, a correction model (210), and one or more words in the sequence of words near the target word. The words may be spoken words, handwritten words, or gesture words. In some embodiments, the expression recognizer may be a speaker independent speech recognizer. The correction model includes conditional probabilities for all word values in a vocabulary, given a particular sequence of words being analyzed, including a target word and words near the tarter word.

### FIELD OF THE INVENTION

The present invention relates generally to human expression recognition and more specifically to speech, handwriting, or gesture recognition using an expression recognition function.

### BACKGROUND

Automated methods and apparatus for recognizing human expressions such as speech, handwriting, and gestures are known that use conventional recognition functions, also called herein expression recognizers. For example, speaker independent speech recognizers are used for telephone answering systems and for some cellular telephones. These speech recognizers are typically fixed recognizers, which is a type also used for many handwriting and gesture recognizers. Fixed expression recognizers, as the expression is used herein, means that the recognizer is not adapted while it is being used; i.e., the databases used to analyze the human expression are not substantially changed after the recognizer is distributed by a manufacturer or after the software is installed, or after a training process is completed. Other conventional expression recognizers may employ limited adaptation techniques that serve to improve the conventional scheme that is used for recognition.

Although such expression recognizers work well in many circumstances, the reliability of their output is not perfect. In some circumstances where expression recognizers are or could be used to advantage because of their greater simplicity, lower power drain and less memory requirements, such as in handheld electronic devices, their performance may suffer. In particular, when such expression recognizers are used substantially by only one person, the resulting error rate may be undesirable due to several factors. For an example of a speech recognizer, the person may have a vocal tract that renders the person's speech in a manner more difficult for the recognizer to interpret than the range of speech for which the recognizer was designed or trained. As another example, the recognizer may not have 100% reliability for any person due to inherent limits in the recognition technology or due to a constant noise in the background. Finally, the person may have a habit of enunciating certain words such that they sound like two words or such that a word is dropped. Such observations pertain to handwriting and gesture systems as well.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present invention.

FIG. 1 is a block diagram of an electronic device being used by a human, in accordance with some embodiments of the present invention;

FIG. 2 is a block diagram of a corrector function of the electronic device, in accordance with some embodiments of the present invention; and

FIG. 3 shows a flow chart of a method used by the electronic device, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to human expression recognition. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

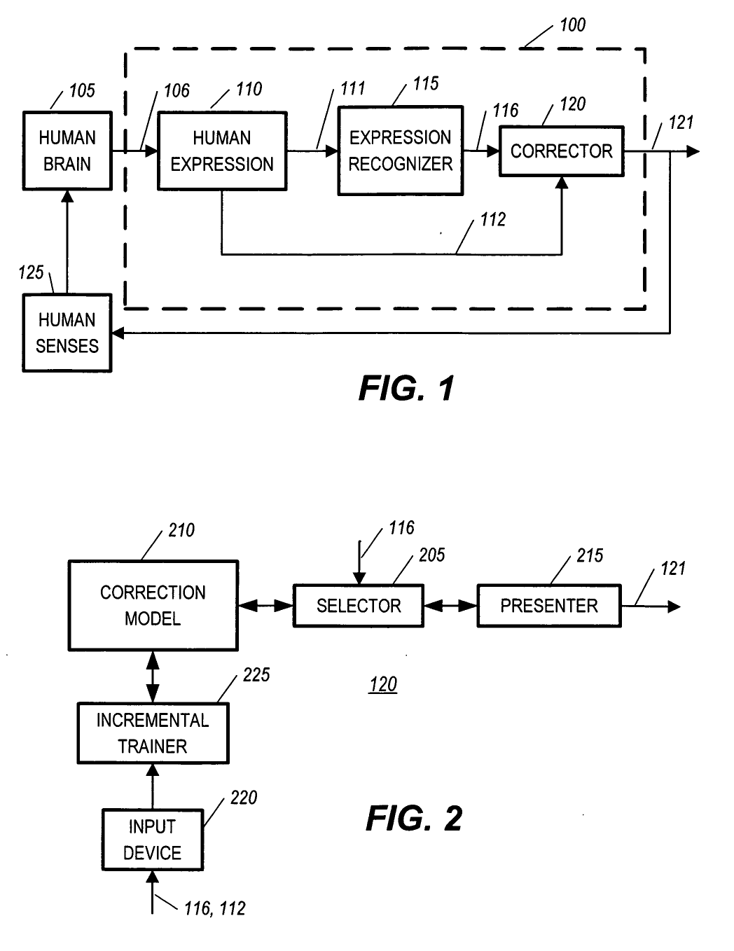

Referring to FIG. 1, a block diagram of an electronic device 100 being used by a human is shown, in accordance with some embodiments of the present invention. The human's brain 105 formulates an intended communication 106 that can be conveyed by a sequence of words, W, that are spoken language words, written language words, or gestures having separable meanings which are also herein called gesture words. The intended communication 106 is then expressed by the person as an expressed sequence of words W′ 111 that are either spoken, written, or gestured (HUMAN EXPRESSION 101 as FIG. 1). It will be appreciated that the expressed sequence of words 111 may not always be exactly equivalent to the intended sequence of words 106. An expression recognizer 115 receives an aspect of the expressed sequence of words 111. For example, a microphone may capture a monophonic portion of the audio of a person's speech, or a touch sensitive display may capture the motion of a person's handheld writing stick at the surface of the display, or a camera may capture an image of a person's arm or hand motion. The expression recognizer 115 may, for example, be a speech recognizer that has been designed for speaker independent recognition of digits using a Hidden Markov Model database and telephone number grammar, as may be used for a cellular telephone, or a handwriting recognizer that requires particular strokes to convey characters, or a gesture recognizer that recognizes several defined hand and arm motions. In some embodiments, the expression recognizer 115 is a trained expression recognizer. In other embodiments, the expression recognizer 115 is a knowledge based expression recognizer, and in yet other embodiments, the expression recognizer 115 is a combination of a trained expression recognizer and a knowledge based expression recognizer. The expression recognizer 115 may be one of a variety of conventional expression recognizers, or may be one that is not yet invented.

The expression recognizer 115 generates a recognized sequence of words W″ 116 that has the most likelihood of representing the expressed sequence of words W′ 111 that it received. This sequence may be generated as digitally encoded text, or, for gestures, it may simply be a sequence of codes. It will be appreciated that the most likely sequence of words 116 may not convey the originally intended communication 106, either because of imperfect conversion from human intention 106to human expressed words 111 or because of inaccurate conversion from human expressed words 111 to the recognized sequence of words 116.

A corrector 120 receives the recognized sequence of words 116 and analyzes the sequence one word at a time. The word being analyzed is termed the target word. To analyze the target word, the corrector 120 provides the target word and one or more words in the sequence near the target word to a correction model, which determines a replacement for the target word. The replacement may be in the form of a substitute word, an added word, or a deletion of the target word. The substitute word may be, in some instances, the original target word. When the corrector 120 has analyzed each word in the recognized sequence of words 116, it then may generate a corrected sequence of words W′″ 121 that may be presented to the human that generated the expressed sequence of words 111.

The presentation of the corrected sequence of words 121 may be performed by a function of the electronic device 100 not shown in FIG. 1. One or more human senses 125 are used to sense the presentation of the corrected sequence of words 121, which are understood by the human's brain 105. The human's brain 105 decides whether the corrected sequence of words 121 are equivalent to the intended communication 106and informs the electronic device of the result of the decision. The informing may be performed by a new sequence of expressed words 111 generated by human expression 110, such as “That is correct” or “That is wrong”, which are recognized by the expression recognizer 115 and acted upon by the corrector 120 as described below to perform incremental training. Alternatively, in some embodiments, the informing may be performed by the human expressing the decision 112 to a decision input function of the corrector 120, which acts upon the decision as described below to perform incremental training.

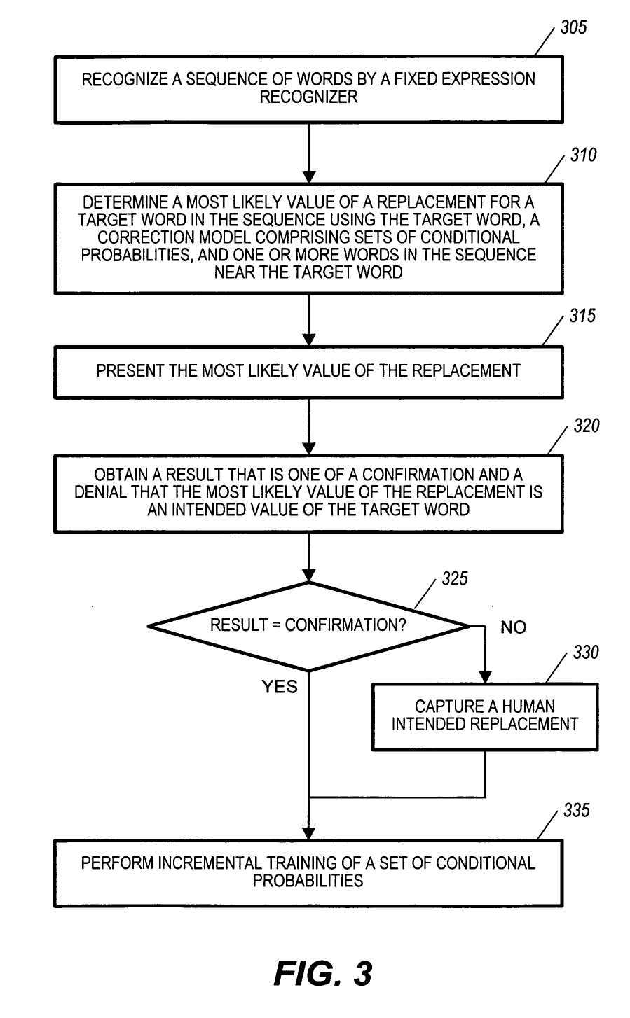

Referring to FIG. 2, a block diagram of the corrector 120 is shown, and referring to FIG. 3, a flow chart of a method used by the electronic device 100 is shown, in accordance with some embodiments of the present invention. These embodiments of the invention will be described using a specific but non-limiting example of a phone number recognizer. In this example, the speech recognizer is a fixed, speaker independent speech recognizer that includes a Hidden Markov Model database and a fixed telephone number grammar that recognizes the ten digits 0 through 9. Although in many instances, such a speech recognizer may also recognize several command words, for the purposes of keeping this example, simple, it is assumed the recognizer recognizes only the ten digits. This may also be expressed as the recognizer having a vocabulary comprising ten unique words that are the ten digits 0-9.

At step 305 (FIG. 3) a sequence of words 116 that comprises digits is recognized by the fixed speech recognizer and coupled to a selector 205. The selector 205 steps through the sequence of digits, selecting each digit at a time, which is called herein the target word, and presenting the target word and the two digits that precede the target word and the two digits that follow the target word to the correction model 210. For an example, assume that a human intended sequence of digits is 8475765054, and assume that the recognized sequence of digits is 8475775054. When the target word is the third 7 of the sequence, the digits 57750 are presented by the selector 205 to the correction model 210. The correction model 210 comprises a set of conditional probabilities for the target word, each conditional probability of the set of conditional probabilities comprising a word value from the vocabulary of words, conditioned by a combination of words from the vocabulary that includes the target word and four words in the sequence near the target word (two directly preceding and two following). Thus, for the specific example given, there could be the following set of conditional probabilities:

TABLE 1

| | | | | | |
|---|---|---|---|---|---|
| R1 | 5 | 7 | 7 | 5 | 0 |

| R2 | 20 | |
|---|---|---|
| R3 | 0 | 0 |
| R4 | 1 | .05 |
| R5 | 2 | 0 |
| R6 | 3 | 0 |
| R7 | 4 | 0 |
| R8 | 5 | 0 |
| R9 | 6 | .95 |
| R10 | 7 | 0 |
| R11 | 8 | 0 |
| R12 | 9 | 0 |

In table 1, row 1 (R1) stores the target word, 7, and the two words (digits, in this example) preceding the target word and the two digits following the target word. Row 2 (R2) stores the number of times that this sequence has been analyzed by the selector 205 and correction model 210, which in this case is 20. The possible word values in the vocabulary (0-9) are listed in the second column. The conditional probabilities for each word value, given the target word and the nearby words (the two preceding and two following words in this example) are listed in the third column. In this example, the conditional probability of the target value being a 6 is 0.95 for the 20 times this sequence has been analyzed in the past.

At step 310 (FIG. 3), the most likely value of a replacement for the target word (7) in the sequence of words is determined, using the target word, the correction model 210, and the four words in the sequence of words near the target word. In this example, the most likely value is 6. The value 6 is returned to the selector 205. This process is repeated for each word in the sequence. After all of the words in the sequence have analyzed in this manner, the replacement values are used to generate a most probable sequence of words, which are provided to the presenter 215 (FIG. 2) and presented at step 315 (FIG. 3) for the human who vocalized the sequence.

It should be noted that there is actually another value used in the vocabulary that wasn't listed in Table 1. That is a value used for one or two unvoiced digits at the beginning or end of set of words being analyzed. Thus, the first sequence of words that would be selected in this example by the selector 205 are ##847, when the symbol for the unvoiced digit is #.

Table 1 is a table for replacement values that are more specifically called substitution values, because the most likely value determined using the set of conditional probabilities defined by table 1 is substituted on a one-to-one basis with the target value. It will be appreciated that in many instances, the substitution value will be the same value as the target word, so that no change occurs. For simplicity of definition, this may still be classified as a substitution. In accordance with embodiments of the present invention, additional conditional probabilities exist for replacements that are made by adding an identified most probable value after the target word, instead of substituting the most probable value for the target value. This accommodates errors in which a digit is dropped from the recognized sequence of words (the dropping of the digit may have occurred by the human expression 110 or the expression recognizer 115, or some partial combination of the two aspects). In some embodiments, yet another conditional probability exists for deleting the target word.

A more complete table for the same target value used in Table 1 is shown in Table 2.

TABLE 2

| | | | | | |
|---|---|---|---|---|---|
| R1 | 7 | 5 | 7 | 5 | 0 |

| R2 | 5 | | 0 |
|---|---|---|---|
| R3 | 0 | 0 | 0 |
| R4 | 1 | 0 | 0 |
| R5 | 2 | 0 | 0 |
| R6 | 3 | 0 | 0 |
| R7 | 4 | 0 | 0 |
| R8 | 5 | 0 | 0 |
| R9 | 6 | 0 | 1 |
| R10 | 7 | 0 | 0 |
| R11 | 8 | 0 | 0 |
| R12 | 9 | 0 | 0 |
| R13 | # | 0 | 0 |

In Table 2, Row 2 (R2) now has two values. The first value is the number of times that this sequence has been analyzed by the selector 205 and correction model 210, which in this case is 5. The second value is the conditional probability for the target word being deleted. For rows 3-13 (R2-R13), there are now three columns. The first two columns are the same as in Table 1. The third column lists the conditional probabilities for adding the word value in the first column to the word sequence, after the target word. Also, row 13 (R13) has been added to include the word value #. For this example, the most likely conditional probability in the table is for adding the word value 6 after the target word, which will generate the intended sub sequence 757650 of the intended full sequenced 8475765054. It should be noted that the sum of the all conditional values (23 in this example), should add to 1.0.

In accordance with the above example, and for more general embodiments of the present invention, it can be seen that when there are M unique words in the vocabulary, there are at most M substitution conditional probabilities, M addition conditional probabilities, and 1 deletion conditional probability in the set of conditional probabilities for the target word. When the number of conditional probabilities in the set of conditional probabilities for the target word is expressed as C, then C≦2M+1. M will clearly be an integer greater than zero.

It will be appreciated that fewer or more than two words directly preceding and directly following the target word could be used to formulate the set of conditional probabilities for a target word, and that the number of preceding words need not be the same as the number of following words. Thus, the sequence near the target word may comprises P words of the sequence directly preceding the target word, and F words of the sequence directly following the target word, wherein P and F are non-negative integers.

The number of sets of conditional probabilities can be seen to be a maximum of M^{(P+F+1)}. In the above example, the number of sets of conditional probabilities is 11⁵. Each table in the above example could have 29 values (the five digits defining the condition, the one value of the number of analyses, the one probability value for the deletion, and the 22 probability values for the substitutions and additions). Thus, the maximum amount of memory that theoretically be used for this example is approximately 425,000 values. However, the tables may be generated only as needed—that is, only when a particular combination of a target value and the nearby letters is first recognized. The actual number of tables needed is typically at least an order of magnitude smaller than the theoretical maximum for many practical uses. For a telephone number application storing 250 telephone numbers, the memory requirements are quite compatible with today's cellular telephones.

Referring again to FIGS. 2 and 3, a technique for updating the sets of conditional probabilities is now described. As mentioned above, at step 315 (FIG. 3) a presentation is made of the most probable sequence of words formed by the replacement values. The human who generated the original human expressed words 111 may then observe (i.e., listen to, watch, read, etc.) the presentation and make a determination as to whether the presentation accurately reflects the human's original intentions. The human may then indicate to the electronic device 100 the result of the determination. The indication may be made by a human expression of words 111 that indicates a confirmation or denial that is processed by the expression recognizer 115 (FIG. 1) and presented to an input device 220 (FIG. 2) of the corrector 120, which transfers the result to an incremental trainer 225 of the corrector 120. Alternatively, the result may be conveyed to the input device 220 of the corrector 120 by a human expression 112 that is not processed by the expression recognizer 115, but rather by another expression recognizer (not shown in FIG. 2), or by a function more rudimentary than an expression recognizer, such as a keypad entry. Thus, the electronic device obtains a result at step 320 that is one of confirmation or denial that the most likely value of the replacement is the intended value of the replacement. At step 325 (FIG. 3), a decision element of the incremental trainer 225 (FIG. 2) interprets the result, and when it is a confirmation, the incremental trainer 225 (FIG. 2) recalculates the conditional probabilities of the set of conditional probabilities for the target word, based on a weighting of existing conditional probabilities that is determined by the quantity of previous incremental trainings of the set of conditional probabilities for the target word. For an example of incremental training when a confirmation is obtained, the recognized sequence described with reference to Table 1 can be used. In that example, the intended word sequence was 8475765054, and the recognized sequence was 8475775054. When the third 7 of the sequence was analyzed, the highest conditional probability was for a substitution value of 6. When the most likely sequence of words is presented, it would be confirmed. Since the values in Table 1 had been generated using 20 occurrences, a new conditional probability for the word value 6 would be calculated as 20/21, or 0.95238, and a new probability for the word value 1 would be calculated as 1/21, or 0.04762, and the other probabilities would remain at 0.

At step 325 (FIG. 3), when the decision element of the incremental trainer 225l (FIG. 2) interprets the result as a denial, the incremental trainer 225 (FIG. 2) interacts with the human, using the presenter 215, and captures a human intended replacement at step 330 (FIG. 3). That is, the human is asked to perform an expression that provides information to convey the originally intended word sequence. This may be done using a variety of methods, one of which would be to request that the human repeat intended expression, which would then be recognized and if confirmed, would then be accepted as the originally intended word sequence. Once the originally intended sequence is obtained, the, incremental trainer recalculates the conditional probabilities of the set of conditional probabilities for the target word, based on a weighting of existing conditional probabilities that is determined by the quantity of previous incremental trainings of the set of conditional probabilities for the target word. For an example of incremental training when a denial is obtained, the recognized sequence described with reference to Table 1 can be used, but in this example, Table 3 is used, in which the maximum conditional probability is associated with an incorrect word value, 3.

TABLE 3

| | | | | | |
|---|---|---|---|---|---|
| R1 | 5 | 7 | 7 | 5 | 0 |

| R2 | 3 | | 0 |
|---|---|---|---|
| R3 | 0 | 0 | 0 |
| R4 | 1 | 0 | 0 |
| R5 | 2 | 0 | 0 |
| R6 | 3 | .6667 | 0 |
| R7 | 4 | 0 | 0 |
| R8 | 5 | 0 | 0 |
| R9 | 6 | .3333 | 0 |
| R10 | 7 | 0 | 0 |
| R11 | 8 | 0 | 0 |
| R12 | 9 | 0 | 0 |
| R13 | # | 0 | 0 |

In this example, the intended word sequence is 8475765054, and the recognized sequence is 8475775054. When the third 7 of the sequence is analyzed, the highest conditional probability is for a substitution word value of 3. When the most likely sequence of words is presented, it would likely be denied. When queried for the correct word values, the human would indicate an intention of 6 for the sixth word in the sequence. Since the values in Table 3 had been generated using 3 previous occurrences, of the recognized sequence 8475775054, in which two were determined to be correct, a new conditional probability for the word value 6 would be calculated as 2/4, or 0.5, and a new probability for the word value 3 would be calculated as 2/4, or 0.5, and the other probabilities would remain at 0. When this table is used again, the corrector 120 would pick one of the two values randomly, since their conditional probabilities are equal. It will be appreciated that the situation of this example, is not very likely to arise in a typical telephone number application, since there would have to be two phone numbers each having a five digit sequence that differs by only one digit from the other.

Thus, an electronic device that includes an expression recognizer has been described that provides for the recognition of human intent, thereby improving the recognition reliability provided by the electronic device in comparison to when the electronic device uses only the expression recognizer. It will be appreciated that these embodiments can provide correction for a speaker's unique vocal aspects, for example an accent or a vocal impediment, for a speaker's habitual errors, and/or for short comings of an expression recognizer without training the expression recognizer to the speaker, using a simple technology.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method to perform recognition of human intent. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for recognizing human intent, comprising:
recognizing a sequence of words by an expression recognizer;
determining a most likely value of a replacement for a target word in the sequence of words using the target word, a correction model, and one or more words in the sequence of words near the target word.

2. The method according to claim 1, wherein the replacement comprises one of a substitution of a substitute word for the target word, an insertion of an added word after the target word, and a deletion of the target word.

3. The method according to claim 1, wherein the expression recognizer is one of a speech recognizer, a handwriting recognizer, and a gesture recognizer and the target word is, respectively, one of a spoken language word, a written language word, and a gesture word.

4. The method according to claim 1, wherein the expression recognizer is one of a trained expression recognizer, a knowledge based expression recognizer, and an expression recognizer that is a combination of a trained expression recognizer and a knowledge based expression recognizer.

5. The method according to claim 1, wherein the correction model comprises a set of conditional probabilities for the target word, each conditional probability of the set of conditional probabilities comprising a word value from a vocabulary of words, conditioned by a combination of words from the vocabulary that includes the target word and the one or more words in the sequence near the target word.

6. The method according to claim 5, wherein there M unique words in the vocabulary and C conditional probabilities in the set of conditional probabilities for the target word, wherein M is an integer greater than zero, and wherein C≦2M+1.

7. The method according to claim 6, wherein there are at most M substitution conditional probabilities, M addition conditional probabilities, and 1 deletion conditional probability in the set of conditional probabilities for the target word.

8. The method according to claim 1, wherein the one or more words in the sequence near the target word comprises P words of the sequence directly preceding the target word, and F words of the sequence directly following the target word, wherein P and F are non-negative integers.

9. The method according to claim 1, further comprising:
presenting the most likely value of the replacement;
obtaining a result that is one of a confirmation and a denial that the most likely value of the replacement is an intended value of the target word; and
performing incremental training of the set of conditional probabilities.

10. The method according to claim 9, wherein performing the incremental training comprises recalculating the conditional probabilities of the set of conditional probabilities for the target word, based on a weighting of existing conditional probabilities that is determined by a quantity of previous incremental trainings of the set of conditional probabilities for the target word, and whether the result is a confirmation or denial.

11. The method according to claim 9, wherein performing the incremental training further comprises capturing a human intended replacement when the result is a denial, and wherein the recalculating of the conditional probabilities is further based on the human intended replacement.

12. A electronic device for recognizing human intent, comprising:
a expression recognizer that recognizes a sequence of words; and
a corrector that determines a most likely value of a replacement for a target word in the sequence of words using the target word, a correction model, and one or more words in the sequence of words near the target word.

13. The electronic device according to claim 12, wherein the corrector comprises a correction model comprising a set of conditional probabilities for the target word, each conditional probability of the set of conditional probabilities comprising a word value from a vocabulary of words, conditioned by a combination of words from the vocabulary that includes the target word and the one or more words in the sequence near the target word.

14. The electronic device according to claim 13, wherein the corrector further comprises:
a presenter that presents the most likely value of the replacement;
a input device that obtains a result that is one of a confirmation and a denial that the most likely value of the replacement is an intended value of the target word; and
an incremental trainer that performs incremental training of the set of conditional probabilities.

15. The electronic device according to claim 14, wherein the input device captures a human intended replacement when the result is a denial, and the incremental trainer bases the incremental training of the set of conditional probabilities upon the human intended replacement.
